(19) United States
(12) Patent Application Publication
(10) Pub. No.: US 2015/0049313 A1
(43) Pub. Date: Feb. 19, 2015

(54) LIGHT SOURCE DEVICE FOR USE IN SELECTABLE ONE OF BACKLIGHT MOUDLE AND PROJECTOR

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/077,227

(22) Filed: Nov. 12, 2013

(30) Foreign Application Priority Data
Aug. 19, 2013 (TW) 102129629

(51) Int. Cl. F21V 8/00; G03B 21/20

(52) U.S. Cl. CPC G02B 6/0031; G03B 21/2033; G03B 21/2066
USPC 353/99; 362/609; 353/98

(57) ABSTRACT

A light source device includes a laser diode module, a light guide plate selectively optically coupled to the laser diode module, a light projector selectively optically coupled to the laser diode module, and a light path switch module located between the laser diode module and the light guide plate and rotatably switched between a first position and a second position to change a light path of a laser beam emitted from the diode module to a first direction and a second direction different from the first direction. Along the first direction, the laser beam is guided to move toward the light guide plate. Along the second direction, the laser beam is guided to move toward the light projector. The light guide plate has a light incident face which is an arced face recessed from a corner of the light guide plate.

### 1. TECHNICAL FIELD

The present disclosure relates generally to a light source device, wherein the light source device which includes a laser diode light source can be conveniently switched to be used between a light source for backlight illumination and a light source for projector lighting.

### 2. DESCRIPTION OF RELATED ART

As a highly effective light source, laser diode (LD) is preferred because its output laser beam has a high degree of monochromaticity. More particularly, the laser diode generates a highly collimated light beam and provides extremely high light intensity output. Thus, the laser diode is widely applied for illumination, such as being used in projectors.

However, since the laser diode generates a highly collimated light beam and a narrow illumination field, it is not suitable to be directly used in backlight module, which greatly limits its application in backlight modules for illuminating a planar display such as a liquid crystal display (LCD). Therefore, such a light source device is difficult to satisfy the requirements of switching between backlight illumination and projector lighting.

What is needed therefore is a light source device which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic view of a light source device in accordance with a first embodiment of the present disclosure, and showing a light path switch module in a first position.

FIG. 2 is similar to FIG. 1, but showing the light path switch module in a second position.

FIG. 3 is a schematic view of a laser diode module of the light source device of FIG. 1.

FIG. 4 is a schematic view of a light source device in accordance with a second embodiment of the present disclosure, and showing a light path switch module in a first position.

### DETAILED DESCRIPTION

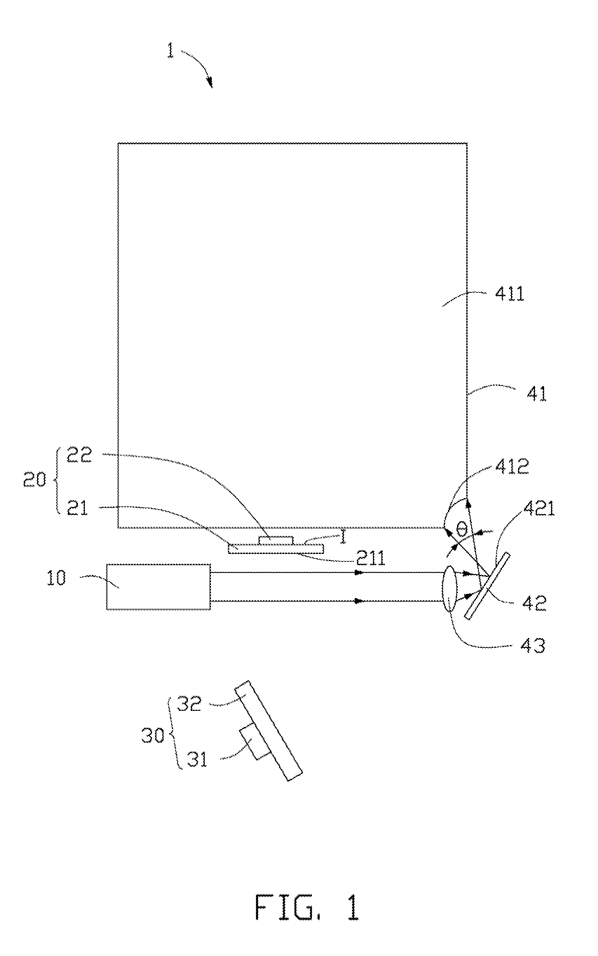

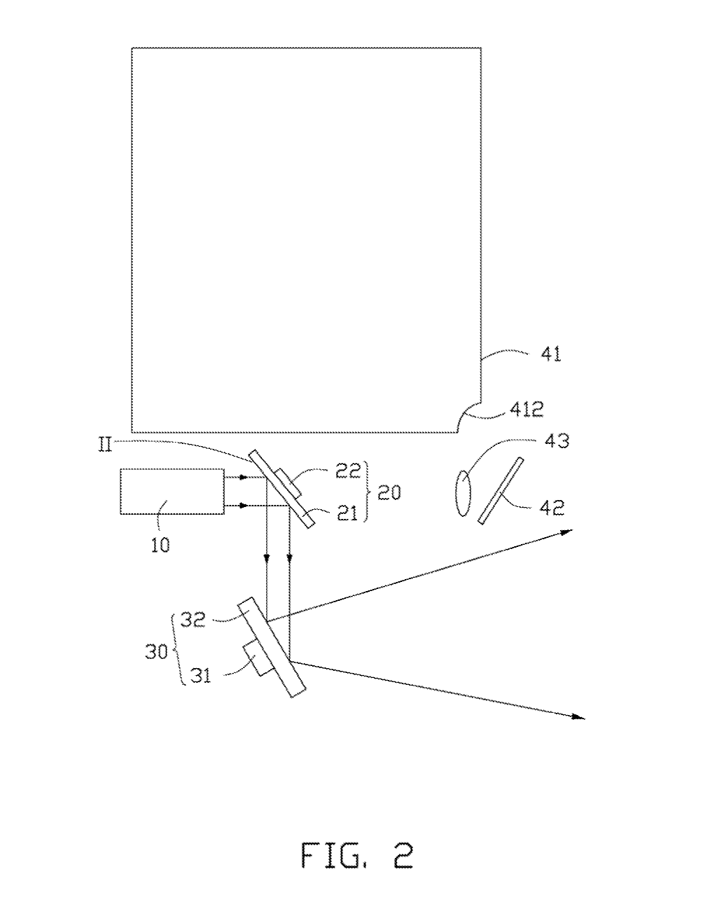

Referring to FIGS. 1 and 2, a light source device 1 in accordance with a first embodiment of the present disclosure includes a laser diode module 10, a light guide plate 41, a light path switch module 20 located between the laser diode module 10 and the light guide plate 41, a focus lens 43 positioned at a light path of the laser diode module 10 and located between the laser diode module 10 and the light guide plate 41, and a second reflecting mirror 42 positioned at the light path of the laser diode module 10 and located between the focus lens 43 and the light guide plate 41, and a laser projection module 30 located beside the laser diode module 10 and being in alignment with the light path switch module 20. The laser projection module 30 is oriented slantwise in respect to the laser diode module 10 and the light guide plate 41. The light guide plate 41 and the laser projection module 30 are selectively optically coupled with the laser diode module 10.

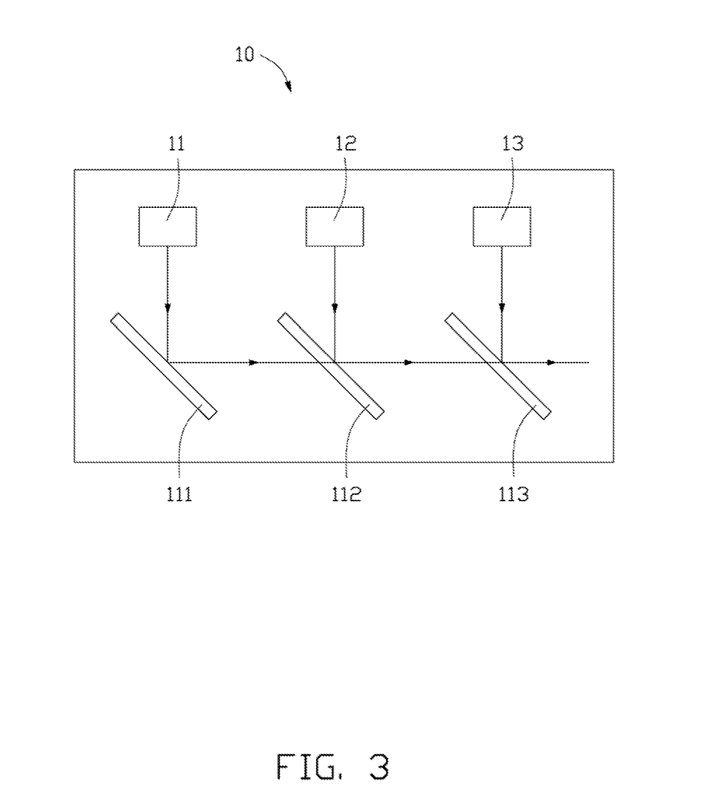

Referring to FIG. 3, the laser diode module 10 includes a first laser diode 11, a second laser diode 12 and a third laser diode 13 parallel to each other. The first laser diode 11 emits a visible red laser beam. The second laser diode 12 emits a visible blue laser beam. The third laser diode 13 emits a visible green laser beam.

The laser diode module 10 further includes a first light filter 111, a second light filter 112 and a third light filter 113 corresponding to and inclined relative to the first, second and third laser diodes 11, 12 and 13, respectively. The visible red laser beam emitted from the first laser diode 11 is totally reflected by the first light filter 111 toward the second light filter 112. The visible blue laser beam emitted from the second laser diode 12 is totally reflected by the second light filter 112 toward the third light filter 113. The visible green laser beam emitted from the third laser diode 13 is totally reflected by the third light filter 113. The reflected visible green laser beam is mixed with the reflected visible blue laser beam passing through the third light filter 113, and the reflected visible red laser beam passing through the second and third light filters 112, 113 to generate a white laser beam output from the laser diode module 10. In the present embodiment, the mixed white laser beam is a near-parallel light beam having a small divergence angle.

Referring to FIGS. 1 and 2 again, the laser diode module 10, the light guide plate 41 and the light patch switch module 20 are located on one plane. The light path switch module 20 is rotatable in the plane relative to the laser diode module 10 between a first position I and a second position II to change a light path of the white laser beam emitted from the laser diode module 10.

The light path switch module 20 includes a first drive motor 22 and a first reflecting mirror 21 mounted on the first drive motor 22. The first reflecting mirror 21 is driven by the first drive motor 22 to rotate in the plane relative to the laser diode module 10 between the first position I and the second position II.

When the light path switch module 20 is located at the first position I relative to the laser diode module 10 as shown in FIG. 1, the white laser beam emitted from the laser diode module 10 propagates in a first direction (i.e., a horizontal direction in the plane) toward the light guide plate 41 via the focus lens 43 and the second reflecting mirror 42, wherein a first reflective surface 211 of the first reflecting mirror 21 of the light path switch module 20 is parallel to the first direction of the white laser beam emitted from the laser diode module 10. That is, when the light path switch module 20 is located at the first position I relative to the laser diode module 10, the white laser beam from the laser diode module 10 is projected directly onto the focus lens 32 without being blocked by the light path switch module 20.

When the light path switch module 20 is located at the first position I relative to the laser diode module 10, the white laser beam propagating in the first direction is converged by the focus lens 43, and then the focused white laser beam exits from the focus lens 43 and is reflected by a second reflective surface 421 of the second reflecting mirror 42 toward a light incident face 412 of the light guide plate 41.

In the present embodiment, an angle defined between the second reflective surface 421 of the second reflecting mirror 42 and the first direction of the white laser beam from the laser diode module 10 is equal to 45 degrees. The second reflective surface 421 of the second reflecting mirror 42 is positioned near a focal plane of the focus lens 43. In more details, the second reflective surface 421 is so placed that an upper boundary of the white laser beam is reflected thereby to enter a lower edge of the light incident face 412 and a lower boundary of the white laser beam is reflected thereby to enter an upper edge of the light incident face 412.

The light guide plate 41 is a rectangular plate. The light guide plate 41 includes the light incident face 412 at a corner thereof which is adjacent to the second reflecting mirror 42, a light exit face 411 adjacent to the light incident face 412, a bottom face adjacent to the light incident face 412 and opposite to the light exit face 411. The light incident face 412 is recessed inwardly in a diagonal direction from the corner of the light guide plate 41 toward an opposite corner of the light guide plate 41. The light incident face 412 is arc-shaped.

In the present embodiment, the white laser beam reflected by the second reflective surface 421 of the second reflecting mirror 42 with an included angle θ smaller than 90 degrees is refracted by the light incident face 412 to have a large included angle of 90 degrees to enter the light guide plate 41 through the light incident face 412, thereby eliminating the dark strip-shaped area inside the light guide plate 41. Thus, the light guide plate 41 having a uniform light distribution inside thereof is obtained.

When the light path switch module 20 is located at the second position II relative to the laser diode module 10 as shown in FIG. 2, the white laser beam emitted from the laser diode module 10 is reflected by the light path switch module 20 in a second direction (i.e., a vertical direction in the plane) toward the laser projection module 30. The first reflective surface 211 of the first reflecting mirror 21 is inclined to the first direction of the white laser beam emitted from the laser diode module 10. In more details, an angle defined between the first reflective surface 211 and the first direction of the laser beam is 45 degrees.

The laser projection module 30 includes a third drive motor 31 and a third reflecting mirror 32 mounted on the third drive motor 31. When the light path switch module 20 is located at the second position II relative to the laser diode module 10, the third reflecting mirror 32 is driven by the third drive motor 31 to rotate in the plane relative to the light path switch module 20 within a predetermined angular range so as to intercept and project the white laser beam reflected by the first reflective surface 211 in the second direction onto a desired target area.

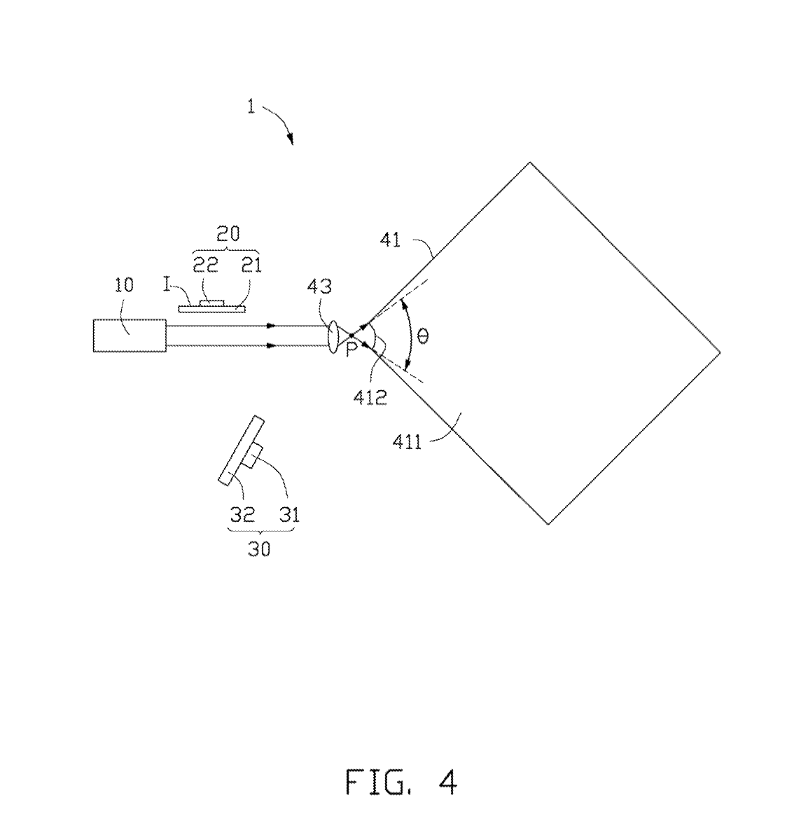

Referring to FIG. 4, different from the light source device 1 shown in FIG. 1, a light source device 1 without the second reflecting mirror 42 in accordance with a second embodiment of the present disclosure is illustrated. In the first embodiment of FIG. 1, the first direction along which the white laser beam leaves the laser diode module 10 is parallel to a side of the light guide plate 41, which defines the light incident face 412 at an end thereof that is distant from the laser diode module 10. In the second embodiment of FIG. 4, the first direction along which the white laser beam leaves the laser diode module 10 is in line with the light incident face 412 of the light guide plate 41. When the light path switch module 20 is located at the first position I relative to the laser diode module 10, the white laser beam projecting in the first direction is directly converged by the focus lens 43 onto the light incident face 412 of the light guide plate 41.

The light incident face 412 of the light guide plate 41 faces the laser diode module 10. Specifically, the light incident face 412 is placed after the focus P of the focus lens 43. When the light path switch module 20 is located at the first position I relative to the laser diode module 10, the focused light exiting from the focus lens 43 with the included angle θ is refracted to be a larger angle, i.e., 90 degrees to enter the light guide plate 41 through the light incident face 412.

In the present disclosure, the light path switch module 20 is rotatable in the plane relative to the laser diode module 10 between the first position I and the second position II to change the light path of the white laser beam emitted from the diode module 10; thus it is convenient for the users to switch the light source device 1 between two different operation modes, i.e., backlight illumination and projector lighting according to the actual requirement. Furthermore, since the laser diode module 10 generates a mixed white laser beam output, the light source device 1 has a high color rendering performance. It is preferred to integrate the light source device 1 into a mobile device in the practical applications, such as mobile phone, tablet computer and a laptop computer, etc.

It is to be understood that the position of the light guide plate 41 relative to the laser diode module 10 in the plane could be changed according to the actual requirements of light path. For instance, the light incident face 412 of the light guide plate 41 is located at a position inclined relative to the laser diode module 10. That is, when the light path switch module 20 is located at the first position relative to the laser diode module 10, the white laser beam emitted from the laser diode module 10 is reflected by the light path switch module 20 in a first direction toward the light guide plate 41; when the light path switch module 20 is located at the second position relative to the laser diode module 10, the white laser beam emitted from the laser diode module 10 is reflected by the light path switch module 20 in a second direction toward the laser projection module 30, and the second direction of the white laser beam is inclined relative to the first direction of the white laser beam.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light source device comprising:
a laser diode module;
a light guide plate selectively optically coupled to the laser diode module; and
a light path switch module located between the laser diode module and the light guide plate;
wherein the laser diode module, the light guide plate and the light path switch module are located on a plane, and the light path switch module is rotatable in the plane relative to the laser diode module from a first position to a second position for changing a light path of a laser beam emitted from the diode module; and
wherein when the light path switch module is located at the first position relative to the laser diode module, the laser beam emitted from the laser diode module projects along a first direction toward the light guide plate, and when the light path switch module is located at the second position relative to the laser diode module, the laser beam emitted from the laser diode module is reflected by the light path switch module in a second direction different from the first direction to be used as a projector light.

2. The light source device of claim 1, wherein the light path switch module comprises a first drive motor and a first reflecting mirror mounted on the first drive motor, and the first reflecting mirror is driven by the first drive motor to rotate in the plane relative to the laser diode module from the first position to the second position.

3. The light source device of claim 2, wherein when the light path switch module is located at the first position relative to the laser diode module, a first reflective surface of the first reflecting mirror of the light path switch module is parallel to the first direction of the laser beam emitted from the laser diode module.

4. The light source device of claim 2, wherein when the light path switch module is located at the second position relative to the laser diode module, a first reflective surface of the first reflecting mirror of the light path switch module is inclined to the first direction of the laser beam emitted from the laser diode module.

5. The light source device of claim 4, wherein an angle defined between the first reflective surface of the first reflecting mirror and the first direction of the laser beam is equal to 45 degrees, and the first direction of the laser beam is perpendicular to the second direction of the laser beam.

6. The light source device of claim 1, wherein the light guide plate comprises a light incident face, a light exit face adjacent to the light incident face and a bottom face opposite to the light exit face, and the light guide plate is a rectangular plate, the light incident face being recessed inwardly along a diagonal direction from a corner of the light guide plate toward an opposite corner of the light guide plate.

7. The light source device of claim 6, wherein the light incident face is arc-shaped.

8. The light source device of claim 7, further comprising a focus lens positioned at a light path of the laser beam when the light path switch module is located at the first position and between the light path switch module and the light guide plate, wherein when the light path switch module is located at the first position relative to the laser diode module, the laser beam propagating in the first direction is converged by the focus lens and directed toward the light guide plate.

9. The light source device of claim 8, wherein the light incident face of the light guide plate faces the laser diode module, and when the light path switch module is located at the first position relative to the laser diode module, the laser beam propagating in the first direction is directly converged by the focus lens onto the light incident face of the light guide plate.

10. The light source device of claim 9, wherein the light incident face of the light guide plate is placed beyond a focus of the focus lens.

11. The light source device of claim 8, further comprising a second reflecting mirror positioned at a light path of the laser beam when the light path switch module is located at the first position and between the focus lens and the light guide plate, wherein when the light path switch module is located at the first position relative to the laser diode module, the focused laser beam exiting from the focus lens is reflected by a second reflective surface of the second reflecting mirror toward the light incident face of the light guide plate.

12. The light source device of claim 11, wherein an angle defined between the second reflective surface and the first direction of the laser beam is equal to 45 degrees.

13. The light source device of claim 12, wherein the second reflective surface of the second reflecting mirror is positioned near a focal plane of the focus lens.

14. The light source device of claim 1, further comprising a laser projection module, wherein the laser projection module comprises a third drive motor and a third reflecting mirror mounted on the third drive motor, wherein when the light path switch module is located at the second position relative to the laser diode module, the third reflecting mirror is driven by the third drive motor to rotate in the plane relative to the light path switch module within a predetermined angular range to intercept the reflected laser beam propagating in the second direction and project the reflected laser beam to a desired target area.

15. The light source device of claim 1, wherein the laser diode module comprises a first laser diode emitting a visible red laser beam, a second laser diode emitting a visible blue laser beam and a third laser diode emitting a visible green laser beam, and the visible green, blue and red laser beams are mixed together to generate a white laser beam output from the laser diode module.

16. The light source device of claim 15, further comprising a first light filter, a second light filter and a third light filter corresponding and inclined to the first, second and third laser diodes, wherein the visible red laser beam emitted from the first laser diode is totally reflected by the first light filter toward the second light filter, the visible blue laser beam emitted from the second laser diode being totally reflected by the second light filter toward the third light filter, the visible green laser beam emitted from the third laser diode being totally reflected by the third light filter, the reflected visible green laser beam being mixed with the reflected visible blue laser beam that passes through the third light filter and the reflected visible red laser beam that passes through the second and third light filters to generate the white laser beam output.

17. A light source device comprising:
a laser diode module for generating a laser beam;
a light guide plate selectively optically connected with the laser diode module;
a light projector selectively optically connected with the laser diode module; and
a light path switch module located between the laser diode module and the light guide plate;
wherein the laser diode module, the light guide plate and the light path switch module are located on a plane, and the light path switch module is rotatable in the plane relative to the laser diode module between a first position and a second position to change a light path of the laser beam emitted from the diode module; and
wherein when the light path switch module is located at the first position relative to the laser diode module, the laser beam emitted from the laser diode module is reflected by the light path switch module in a first direction toward the light guide plate, and when the light path switch module is located at the second position relative to the laser diode module, the laser beam emitted from the laser diode module is reflected by the light path switch module in a second direction to the light projector, the second direction being different from the first direction.

18. The light source device of claim 17, further comprising a focus lens positioned at a path of the laser beam when the laser beam is reflected by the light path switch module in the first direction and between the light path switch module and the light guide plate, wherein when the light path switch module is located at the first position relative to the laser diode module, the laser beam propagating in the first direction is converged by the focus lens and directed toward the light guide plate.

19. The light source device of claim 18, wherein the light guide plate is a rectangular plate and so located that a corner of the light guide faces and is in line with the laser diode module, the corner being recessed inwardly to form an arced-shaped light incident face.

20. The light source device of claim 18, further comprising a light reflector located at the path of the laser beam when the laser beam is reflected by the light path switch module in the first direction and between the focus lens and the light guide plate, wherein the light guide plate has an arced light incident face recessed from a corner thereof which is distant from the laser diode module, and the laser beam reflected by the light path switch module in the first direction and converged by the focus lens being reflected by the light reflector to enter the light guide plate via the arced light incident face.
